(19) United States
(12) Patent Application Publication
(10) Pub. No.: US 2021/0004763 A1
(43) Pub. Date: Jan. 7, 2021

(54) VEHICULAR FLEET ROUTING SYSTEM AND METHOD

(71) Applicant: FLIPKART INTERNET PRIVATE LIMITED, BANGALORE (IN)

(72) Inventor: Venkateshan Kannan, Bangalore (IN)

(73) Assignee: FLIPKART INTERNET PRIVATE LIMITED, BANGALORE (IN)

(21) Appl. No.: 16/921,763

(22) Filed: Jul. 6, 2020

(30) Foreign Application Priority Data
Jul. 5, 2019 (IN) 201941026942

(51) Int. Cl. G06Q 10/08; G06Q 10/04

(52) U.S. Cl. CPC G06Q 10/08355; G06Q 10/047; G06Q 10/0838

(57) ABSTRACT

The present disclosure provides system [100] and method [200] for vehicular fleet routing for shipment delivery. The system determines the routes based on a cost model that includes one or more of total travel time, route properties such as compactness, even distribution of shipments and route outliers while working within bounds on one more of vehicle capacity and delivery time-windows. The method encompasses receiving, at least one input comprising a set of locations to be serviced and a location of a hub. Thereafter, the method determines an initial set of routes between the hub and the set of locations satisfying one or more capacity constraints. The method further comprises modifying, iteratively, the determined initial set of routes based on a combination of multiple operations that reconfigure the routes to arrive at a final configuration of routes.

### CROSS REFERENCE TO RELATED APPLICATIONS

This application claims priority to Indian Patent Application No. 201941026942, filed on Jul. 5, 2019, the disclosure of which is hereby incorporated by reference in its entirety.

### FIELD OF THE DISCLOSURE

The field generally relates to transport optimization and shipment delivery planning and scheduling. More particularly, the field relates to systems and methods for vehicular fleet routing.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Transport optimization is extremely important in shipment delivery planning and scheduling in order to increase the efficiency of shipment delivery solutions and also to reduce the cost of shipment delivery. Existing shipment delivery solutions are often based on manual scheduling and route planning for each vehicle which is inefficient and not viable for large scale delivery. Although certain automated route planning solutions have also been developed over the past few years, they primarily focus on minimizing the total travel time taken for shipment delivery. These solutions do not take into account other desirable attributes of the plan such as even distribution of shipments across vehicles, reduction of outliers on route and minimization of spatially extended routes. Also, breaches of time windows for delivery that may be inevitable in some cases are also not taken into account by the existing solutions. Further, these solutions do not accommodate inclusion of mandatory rest slots along the route with a finite start-time window. All of these are desirable attributes in real world shipment delivery route determination especially in a geographical area of 100 sq. km or less.

In view of the above-mentioned limitations of the existing solutions, there exists a need in the art to provide more efficient systems and methods for vehicular fleet routing.

### SUMMARY

This section is provided to introduce certain objects and aspects of the present disclosure in a simplified form that are further described below in the detailed description. This summary is not intended to identify the key features or the scope of the claimed subject matter.

In order to overcome at least a few problems associated with the known solutions, an object of the present disclosure is to provide a novel method and system for vehicular fleet routing. Another object of the present disclosure is not only to decrease the total travel time during a shipment delivery but also to reduce regions having overlapping routes. It is another object of the present disclosure to provide systems and methods for vehicular fleet routing that minimizes service time window breaches and ensures even distribution of shipments across vehicles. Another objective is to provide the necessary flexibility in terms of determining the relative importance of these different objectives depending on the real-world conditions at a given delivery zone. Yet another objective here is generating routing solutions that satisfy rest time slot requirements for the agents running the delivery tasks. Further, this invention enables carrying out a systematic and comprehensive investigation of the results of implementation of the routing system in a real-world context and using that as feedback to set the many hyper-parameters of the models more accurately or redefine the functional relations between the input variables and the various cost factors.

Another object of this invention is effective reduction in computational complexity of the procedure both for constructing an initial set of feasible routes as well as for the iterative process of improvement through several operations. More specifically, the invention aims to considerably reduce the number of steps (or choices to consider) at different stages of the procedure with minimal impact on the final solution by computing a relevant subset which has a higher probability of containing the most optimal transition.

In order to achieve the afore-mentioned objectives, one aspect of the present disclosure relates to a method for vehicular fleet routing. The method encompasses receiving, at a transceiver unit, at least one input comprising a set of locations to be serviced and a location of a hub. Thereafter, the method comprises determining, via a processing unit, an initial set of routes between the hub and the set of locations, the initial set of routes being associated with a first cost, wherein determining the initial set of routes further comprises inserting, iteratively, one or more un-routed locations into one or more partially constructed routes based on an insertion cost. The method thereafter comprises modifying, iteratively, via the processing unit, the determined initial set of routes based on at least one of ejection of at least one location from one or more routes and subsequent re-insertion of the ejected at least one location in the one or more routes, wherein the ejected at least one location is re-inserted one at a time, switching one or more locations between a pair of routes and swapping one or more route segments between a pair of routes. The method further encompasses determining at each iteration, via the processing unit, a second cost associated with the modified set of routes and an acceptance criteria associated with one or more modifications. The method further encompasses selecting, via the processing unit [104], a route modification criteria based on one or more iterations. Thereafter, the method encompasses arriving, via the processing unit, at a final set of routes based on a stopping criteria.

Further, another aspect of the present disclosure relates to a system for vehicular fleet routing. The system comprises a transceiver unit, configured to receive, at least one input comprising a set of locations to be serviced and a location of hub. The system further comprises a processing unit, configured to determine, an initial set of routes between the hub and the set of locations, the initial set of routes being associated with a first cost, wherein the processing unit in order to determine the initial set of routes is further configured to insert, iteratively, one or more un-routed locations into one or more partially constructed routes based on an insertion cost. Thereafter the processing unit is further configured to modify, iteratively, the determined initial set of routes based on at least one of ejection of at least one location from one or more routes and subsequent re-insertion of the ejected at least one location in the one or more routes, wherein the ejected at least one location is re-inserted one at a time, switching one or more locations between a pair of routes, and swapping one or more route segments between a pair of routes. Further the processing unit is configured to determine at each iteration a second cost associated with the modified set of routes and an acceptance criteria associated with one or more modifications. The processing unit thereafter is also configured to arrive at a final set of routes based on a stopping criteria.

### BRIEF DESCRIPTION OF THE DRAWINGS

The accompanying drawings, which are incorporated herein, and constitute a part of this disclosure, illustrate exemplary embodiments of the disclosed methods, devices and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100], for vehicular fleet routing, in accordance with exemplary embodiments of the present disclosure.

FIG. 2 illustrates an exemplary method flow diagram [200], depicting method of vehicular fleet routing, in accordance with exemplary embodiments of the present disclosure.

FIG. 3 illustrates an example of inserting, an un-routed location/customer into a partially constructed route based on an insertion cost, in accordance with exemplary embodiments of the present disclosure.

FIGS. 4(a)-4(c) illustrate an example of modifying a set of routes, in accordance with exemplary embodiments of the present disclosure.

The foregoing shall be more apparent from the following more detailed description of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The present disclosure relates to systems and methods of vehicular fleet routing. Also, the present disclosure provides a solution relating to route optimization during shipment delivery and scheduling in heterogeneous hubs. The invention aims to achieve efficient planning of routes for servicing a set of locations at specified time windows from a given hub by a certain number of vehicles. Also, the present disclosure in order to provide a solution relating to optimal routing of shipments, takes into consideration a number of cost parameters associated with outliers on routes, uneven distribution of shipments across the vehicles and non-compactness of routes aside from constraints associated with capacity of the vehicles and arrivals at customer locations within their respective time-windows. Furthermore the present disclosure encompasses generating an initial set of routes followed by an improvement in the generated initial set of routes that iteratively deploys a collection of distinct operations such as removal and reinsertion of one or more locations/customers in one or more routes, exchange of the one or more locations between the one or more routes, reordering the traversal of one or more customers/locations within a route, and insertion of the one or more locations in routes with recursive transfers etc. This iterative deployment of a collection of distinct operations reconfigures the present solution both within and between routes. Also, the present disclosure encompasses providing at least one rest slot to wish-masters/delivery agents delivering shipments to customers. Also, the key features as disclosed in the present disclosure are implemented via at least one processing unit, at least one storage unit, at least one transceiver unit and one or more modules configured to perform one or more functions in accordance with the invention. Further, the modules may be program modules stored in the memory, or hardware modules associated with the processor.

As used herein, “servicing” refers to a shipment delivery and a “hub” refers to a place or location from where shipment is routed for delivery at one or more desired locations. The sorting and loading of shipments also occurs at the hub.

As used herein, a “set of locations” refers to a set of customers to be serviced by the hub. Further, each customer from the set of customers is associated with geographic coordinates of corresponding location.

As used herein, “vehicles” may refer to two wheeler, three wheeler, four wheeler or any other similar vehicles. Vehicles may further be personal or commercial vehicles. As used herein, “vehicular fleet” refers to one or more vehicles.

As used herein, a “first cost” refers to a cost associated with an initial set of routes.

As used herein, a “second cost” refers to a cost associated with a modified set of routes.

As used herein, a “processing unit” or “processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, a “transceiver unit” may comprise one or more transmitter units and one or more receiver units, configured to transmit and receive respectively, at least one of one or more signals, data and commands from various units/modules, to implement the features of the present disclosure. The transceiver unit may be any such transmitting and receiving unit known to the person skilled in the art, required to implement the features of the present disclosure.

As used herein, “memory unit”, “storage unit” and/or “memory” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. Any of the methods herein can be implemented in one or more computer-readable media comprising computer-executable instructions that, when executed, cause a computing system to perform the method.

The present disclosure is further explained in detail below with reference now to the diagrams.

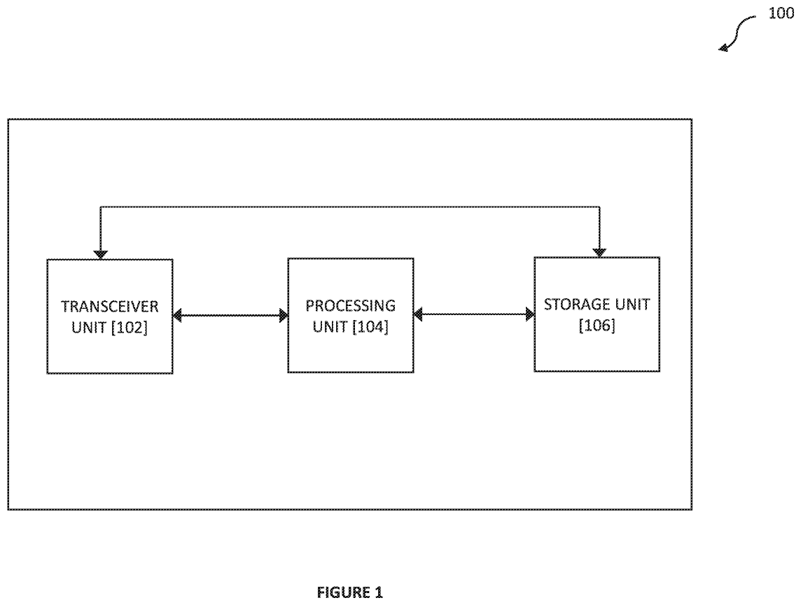

Referring to FIG. 1, an exemplary block diagram of a system [100], for vehicular fleet routing, in accordance with exemplary embodiments of the present disclosure is shown.

The system [100] comprises, at least one transceiver unit [102], at least one processing unit [104] and at least one storage unit [106]. All of these components/units are assumed to be connected to each other unless otherwise indicated below. Furthermore, the system [100] may also comprise other units such as a display unit, an input unit, an output unit and the like, however the same are not shown in the FIG. 1 for the purpose of clarity. Also, in FIG. 1 only few units are shown, however the system [100] may comprise multiple such units or the system [100] may comprise any such numbers of said units, obvious to a person skilled in the art or as required to implement the features of the present disclosure.

The system [100], is configured to provide a solution relating to vehicular fleet routing, with the help of the interconnection between the components/units of the system [100].

The at least one transceiver unit [102] is configured to receive, at least one input comprising a set of locations to be serviced and a location of a hub. Also, the set of locations may further comprise one or more geographical details such as including but not limited to—coordinates (ex, geographical coordinates of latitude, longitude) etc. Further the one or more locations of the received set of locations are equivalent to one or more customers required to be serviced.

Further, the at least one input comprises at least one travel time between each pair of locations, a number of vehicles, a service time associated with each location, a number of shipments associated with each location and one or more maximum capacity details of each vehicle. Also, in an instance the one or more maximum capacity details may refer to one or more capacity details specified on the basis of at least one of a length-breadth-height [LBH] parameter and a number of shipments. Furthermore, in an instance the at least one input further comprises one or more serviceable time windows associated with each location.

Further the at least one processing unit [104] is connected to the at least one transceiver unit [102]. The processing unit [104] is configured to determine, an initial set of routes between the hub and the set of locations, the initial set of routes being associated with a first cost, wherein the processing unit [104] in order to determine the initial set of routes is further configured to insert, iteratively, one or more un-routed locations into one or more partially constructed routes based on an insertion cost. Also, the insertion cost is a cost associated with the insertion of the one or more locations/customers into the one or more partially constructed routes.

Further the insertion cost is based on at least one of an increase in, a travel time, a shrinkage in time-window width, one or more penalties in an event the one or more locations are geographical outliers and a non-compactness of the set of locations constituting the one or more routes. Also, in an instance, the insertion cost is further based on at least one location in the one or more partially constructed routes, at which the location/customer that are required to be inserted. For example, if a customer I is to be inserted in a partially constructed route ABC, then the insertion cost of the customer I between two points A and B may be different from the insertion cost of the customer I between two points B and C.

Also, the processing unit [104] is configured to identify an un-routed customer/location that is required to be inserted into partially constructed routes, based on a minimization of an insertion cost.

Further in an implementation the processing unit [104] is also configured to scale one or more cost components to adapt to one or more input conditions. For instance, the scaling of the one or more cost components ensures that one cost component does not dominate, or is not dominated by, one or more other cost components.

In certain implementations, the processing unit [104] is also configured to assign a rest slot within each route. The processing unit [104] is therefore configured to determine a position of the rest slot based on a slot duration and a time-window representing a permissible start of the slot duration. Further, in an instance the processing unit [104] is also configured to consider each rest slot as a ‘virtual’ customer which shares certain similarities with true customers but not all. Further, in such instance, an equivalent of a service time for the rest slot is an actual rest duration (i.e. the slot duration). Further, as the rest slot does not map to any physical location, the processing unit [104] is configured to set a travel time between the rest slot and other customers to be zero. Also, further in instances where travel time between two customers on a route separated by such a rest slot may be incorrectly upper-bounded by 0, an update procedure for a customer before (after) the rest slot takes into account a customer after (before) the rest slot as well.

Thereafter, the processing unit [104] is also configured to modify, iteratively, the initial set of routes. The processing unit [104] is further configured to modify, iteratively, the determined initial set of routes based on at least one of ejection of at least one location from one or more routes and subsequent re-insertion of the ejected at least one location in the one or more routes, wherein the ejected at least one location is re-inserted one at a time, switching one or more locations between a pair of routes, and swapping one or more route segments between a pair of routes.

Further, in an instance the processing unit [104] is configured to modify, iteratively, the initial set of routes by providing at least one of one or more inter-route and one or more intra-route reconfiguration of the one or more customers/locations based on the switching of the one or more locations/customers in the one or more routes.

Further, in another instance, the processing unit [104], in order to switch one or more locations between a pair of routes, is configured to identify a pair of neighboring routes first and thereafter the processing unit [104] is further configured to swap the one or more locations between them. Also, the determination of the route-pair in such instances may be based on a selection of an initial route at random, followed by identifying the one or more customers required to be removed from it, and then finding a neighboring route that is nearest to the one or more customers being removed. Also, in an instance the selection of route-pair and the one or more customers to be removed is further based on a reduction or elimination of a total capacity breach.

Also, in another instance, the processing unit [104], in order to switch one or more locations between a pair of routes may be configured to identify a cluster of customers that are placed in two or more existing routes. Further, for a pair of routes among the two or more existing routes, customer segments within each route are identified and swapped. In one implementation, the two customer segments, one in each route, are determined by also considering capacity constraints requiring that the number of customers in each route is less than a threshold. Thereafter, the processing unit [104] is further configured to analyse an impact of a customer segment swap on an overall cost including cost associated with time-window violations. Further, the customer segment swaps iterates over all combinations of traversals of the customer segment pair.

Furthermore, in one more instance, the processing unit [104] is configured to identify one or more route pairs, based on ranking the one or more route pairs on the basis of distance between their centroids. Further, said one or more route pairs are identified for switching/swapping the one or more locations between them. Thereafter, the processing unit [104] is configured to assign the one or more route pairs, a probability inversely proportional to square root of the rank (i.e. of the distance), to further determine the route pair based on that probability. Once the route pair is determined, the processing unit [104] is thereafter configured to identify one or more customer segments at random, both in terms of their starting index and their length with a constraint that the number of customers does not exceed a threshold.

In another implementation, the processing unit [104], in order to eject and re-insert the at least one location in the one or more routes, is further configured to remove a first subset of locations from the initial set of routes. Thereafter, the processing unit [104] is configured to restore the one or more routes based on a second subset of locations. Also, the first subset of locations comprises one or more locations that are required to be ejected from the one or more routes and the second subset of locations comprises one or more locations remaining in the one or more routes after ejecting/removing the first subset of locations. Also, the processing unit [104] is configured to remove the first subset of locations from the one or more routes based on at least one of a proximity to a specific (randomly chosen) location, a random selection of locations and a cost contribution of each customer. In another implementation, the processing unit [104] may be configured to remove a first subset of locations that violates time-window constraints.

Further, while restoring the one or more routes after removal of the first subset of locations, the processing unit [104] is configured to update time-windows associated with the remaining customers/location (i.e. the second subset of locations). For instance, if 15 customers are removed from a route Z comprising a total of 65 customers initially, the processing unit [104] in such instance is configured to update the time-windows associated with each of the remaining 50 customers over the route Z.

Also, the processing unit [104] is thereafter configured to reset the time-windows (to their original inputs) associated with the first subset of customers. Further, considering the above stated example, the processing unit [104] is further configured to reset the time-window associated with each of the removed 15 customers.

The processing unit [104] is further configured to reinsert, the first subset of locations, one at a time, into the one or more routes, based on the insertion cost. Further, in one implementation, the reinsertion order of one or more locations/customers of the first subset of locations is determined based on preliminary computation of a minimum total increase in a travel time and a shrinkage of time-windows due to the insertion of the one or more customer at a location in the one or more routes. Thereafter, once the reinsertion order is determined, the processing unit [104] is further configured to reinsert the first subset of locations, one location/customer at a time, in the one or more routes, based on a minimization of the insertion cost as described during determining the initial set of routes. Further, considering the above stated example the processing unit [104] is further configured to reinsert each of the 15 removed customers, one at time, in the one or more routes, based on the insertion cost.

Furthermore, the processing unit [104] is also configured to modify, iteratively, the initial set of routes in scenarios where time-window violations are inevitable. In one implementation, the criteria to identify at least one insertion location to insert the one or more locations may be based on a weighted linear combination of minimizing a total increase in travel time and an extent of breach (i.e., difference between an arrival time and an end of time-window of a customer). Also, the extent of breach in a route is associated with a sum of increase in breaches of all customers/locations in that route upon inserting a new customer.

In another operation, the processing unit [104] while inserting one or more customers/locations into the one or more routes is further configured to transfer recursively the one or more locations from one route to another route, wherein the recursive transfer is based on at least one of a sum of costs incurred in all the transfers and a capacity constraint of the route. For instance, a recursive chain of transfers would involve moving customer c to route r1 from where customer c1 is moved to route r2 and so on. Further in such instance the criteria for identifying the customer to remove and one or more routes into which the customer is required to insert at any stage, is based on the sum of the costs incurred in all the moves while not exceeding a capacity constraint of the route. Further, the cost associated with each move/transfer is compared to a regular insertion cost and is implemented only in an event it is favorable in comparison and indicates a reduced cost. Further, the principal advantage of the recursive transfer of the one or more locations is that it provides a workaround for insertion of the one or more locations into one or more routes that would otherwise breach the shipment capacity constraints.

Furthermore, the processing unit [104] in order to modify, iteratively, the determined initial set of routes is further configured to reconfigure an ordering of locations on the route. For instance, the processing unit [104] is configured to exchange/reorder one or more locations/customers between a pair of routes, wherein each of these routes is further optimized independently by considering one or more standard edge-exchange operations within and between routes, such as all possible 2-edge exchanges and/or the like edge-exchange operations may be considered.

Also, in an implementation the processing unit [104] is further configured to reduce a computational complexity of one or more procedures. Therefore the processing unit [104], in order to reduce the computational complexity, is further configured to identify, at least one of a subset of neighboring locations of the one or more locations and a subset of routes, during the one or more location insertions. Also, the processing unit [104] in order to reduce the computational complexity, is further configured to maintain, an information based on a cost computed from one or more previous iterations of the insertion of the one or more locations in the one or more routes at one or more locations to save re-computation in subsequent steps. Further, the processing unit [104], in order to reduce the computational complexity, is further configured to eliminate, one or more options, in the one or more routes based on a shipment capacity. Also, the processing unit [104], in order to reduce the computational complexity, is further configured to eliminate one or more options, based on one or more time-windows and one or more serviceable times. For instance, in order to eliminate the one or more options, based on the one or more time-windows and the one or more serviceable times the processing unit [104] is configured to determine if the earliest (latest) arrival time at a next (previous) customer is greater (lesser) than its latest (earliest) serviceable time.

Also, the processing unit [104] is further configured to ensure the requirements of the rest slot in every route. The rest slots are usually not dislodged from a route during inter-route reconfiguration operations; in instances involving swapping customer-segments/route-segments between a route pair, the move is permissible only when both the route-segments contain rest slots or neither of them do.

Also, in an instance, the processing unit [104] is further configured to modify, iteratively, the determined initial set of routes based on at least one combination of above disclosed features to provide better route optimization during shipment deliveries and scheduling in heterogeneous hubs. Furthermore, the processing unit [104], in order to select the at least one combination of above disclosed features, is further configured to assign probabilities to the above defined features based on how often the overall cost reduces in the previous iterations.

Also, the processing unit [104] instead of accepting only those moves/transfers that reduce the overall cost, is also configured to provide a simulated annealing procedure to explore configurations that could lead to short-term increase in the cost but helps to avoid getting trapped in local minima. In one implementation, the simulated annealing is skipped for moves which inherently contain an acceptability criterion.

Further, at each iteration, once the routes are modified, the processing unit [104] is further configured to determine at each iteration a second cost associated with the modified set of routes and an acceptance criteria associated with one or more modifications.

Further, the processing unit [104] is also configured to select, a route modification criteria based on one or more iterations. Also, thereafter, the processing unit [104] is further configured to arrive, at a final set of routes based on a stopping criteria. Also, one implementation of the stopping criteria may be a total number of iterations reaching a specified limit, based on which the processing unit [104] arrives at the final set of routes.

Also, the at least one storage unit [106] is connected to the at least one processing unit [104] and the at least one transceiver unit [102]. The storage unit [106] is configured to store one or more data required to be stored in order to further implement the features of the present disclosure.

Furthermore, the system [100] is configured to provide a number of techniques to reduce computational processing required to optimize the one or more routes. One example is arriving at a feasible subset of insertion locations, by first eliminating via the processing unit [104], one or more options in the initial subset of routes that exceed a shipment capacity and thereafter by determining via the processing unit [104] if the earliest (latest) arrival time at a next (previous) customer is greater (lesser) than its latest (earliest) serviceable time.

Thereafter, the processing unit [104] is configured to sort one or more customers adjacent to one or more insertion locations based on a travel time associated with the one or more customers. Another example is to retain information about an insertion cost associated with insertion of a specific customer in a specific route, as this would prevent re-computation of the cost as long as the route remains unchanged. Also, one more example relates to one or more approximations used to reduce the number of configurations required for evaluating implementations of one or more edge exchanges, based on various factors such as ignoring a configuration that may increase a travel time and/or a time-window violation by a certain fraction.

Further, the system [100] is also configured to provide route optimization in various modes where a route capacity constraint may be violated at an intermediate stage in order to explore the solution space more thoroughly, but these capacity constraints are restored via the system [100] while implementing the features of the present disclosure.

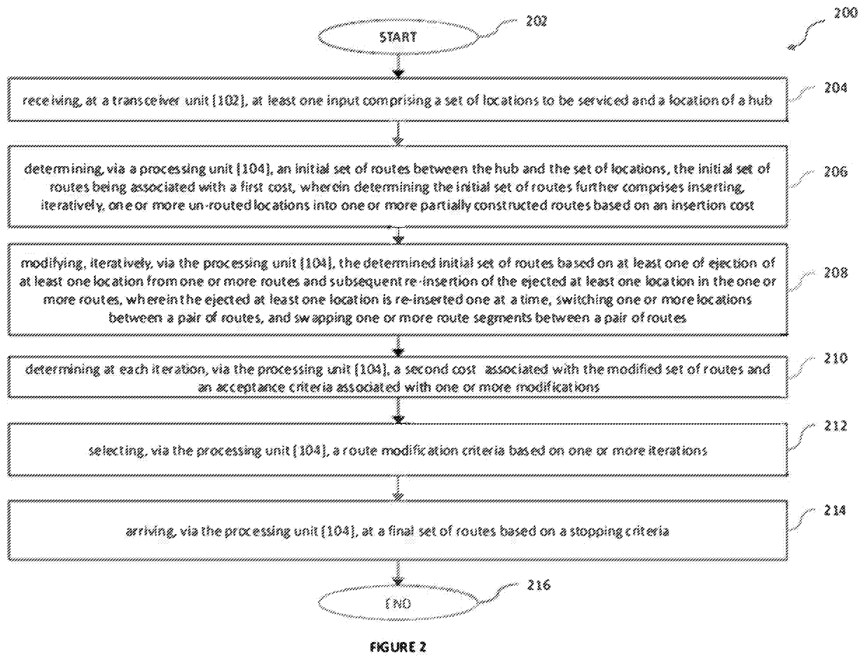

Referring to FIG. 2, an exemplary method flow diagram [200], depicting a method of vehicular fleet routing, in accordance with exemplary embodiments of the present disclosure is shown. As shown in FIG. 2, the method begins at step [202].

At step [204], the method comprises receiving, at a transceiver unit [102], at least one input comprising a set of locations to be serviced and a location of a hub. Also, the set of locations may further comprise one or more geographical details such as including but not limited to—coordinates (such as geographical coordinates i.e. latitude, longitude) etc. Further the one or more locations of the received set of locations are equivalent to one or more customers required to be serviced by the hub.

Further, the at least one input comprises at least one travel time between each pair of locations, a number of vehicles, a service time associated with each location, a number of shipments associated with each location and one or more maximum capacity details of each vehicle. In another implementation, the input may also comprise one or more service time windows associated with each location.

Next, at step [206], the method comprises determining, via a processing unit [104], an initial set of routes between the hub and the set of locations, the initial set of routes being associated with a first cost, wherein determining the initial set of routes further comprises inserting, iteratively, one or more un-routed locations into one or more partially constructed routes based on an insertion cost. Further, the insertion cost is a cost based on the insertion of the one or more locations/customers into the one or more partially constructed routes.

Also, the insertion cost is based on at least one of an increase in, a travel time, a shrinkage in time-window width, one or more penalties in an event the one or more locations are geographical outliers and a non-compactness of the set of locations constituting the one or more routes. Also, in an instance, the insertion cost is further based on at least one location in the one or more partially constructed routes, at which the location/customer that are required to be inserted.

Thereafter, the method also encompasses identifying via the processing unit [104], the one or more un-routed locations that are required to be inserted into the one or more partially constructed routes, based on a minimization of an insertion cost. Also, in an implementation the method further comprises scaling one or more cost components to adapt to one or more input conditions. For instance, the scaling of the one or more cost components ensures that one cost component does not dominate, or is not dominated by, one or more other cost components.

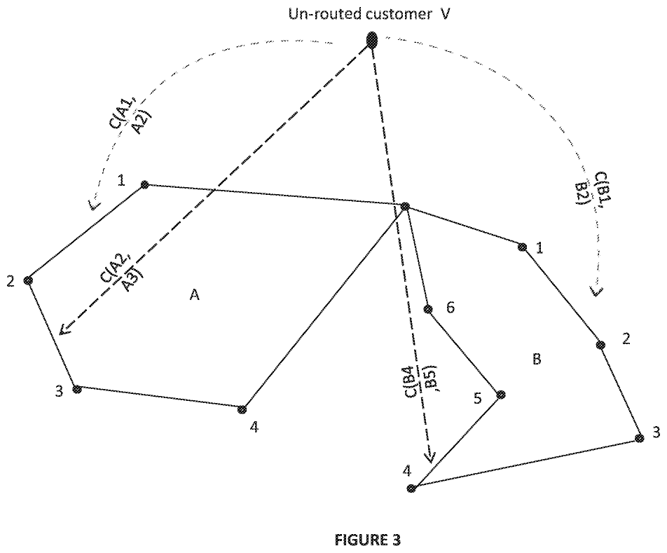

Furthermore, referring to FIG. 3, an example of inserting, an un-routed location/customer into a partially constructed route based on an insertion cost, in accordance with exemplary embodiments of the present disclosure is shown.

As shown in FIG. 3, V is an un-routed customer that is to be inserted into a partially constructed route.

Also, in FIG. 3 the two partially constructed routes A and B are indicated. Further a cost is associated with each of these partially constructed routes i.e. with A and B. Further in order to insert V into a partially constructed route the insertion location is chosen from multiple possible insertion locations, based on the insertion cost.

For instance, the FIG. 3 indicates insertion costs C (A1, A2) and C (A2, A3) associated with insertion locations in the route A and insertion costs C (B1, B2) and C (B2, B3) associated with insertion location in the route B.

Further, the un-routed customer V is inserted at an insertion location associated with the minimum insertion cost.

In another implementation, the method may also comprise assigning via the processing unit [104], at least one rest slot within each route. Further, the method also encompasses determining via the processing unit [104] a position of the rest slot based on a slot duration and a time-window representing a permissible start of the slot duration. The method considers each rest slot as a ‘virtual’ customer which shares certain similarities with true customers but not all. Further, an equivalent of a service time for the rest slot is an actual rest duration (i.e. the slot duration). Further, as the rest slot does not map to any physical location, the method comprises setting via the processing unit [104], a travel time between the rest slot and other customers to be zero. Also, further in instances where travel time between two customers on a route separated by such a rest slot may be incorrectly upper-bounded by 0, an update procedure for a customer before (after) the rest slot takes into account a customer after (before) the rest slot as well.

Further, at step [208], the method comprises modifying, iteratively, via the processing unit [104], the determined initial set of routes based on at least one of ejection of at least one location from one or more routes and subsequent re-insertion of the ejected at least one location in the one or more routes, wherein the ejected at least one location is re-inserted one at a time, switching one or more customers/locations between a pair of routes of, and swapping one or more route segments between a pair of routes.

Further, in an instance the method encompasses modifying, iteratively, the initial set of routes, by providing via the processing unit [104], at least one of one or more inter-route and one or more intra-route reconfiguration of the one or more customers based on the switching of the one or more locations/customers in the one or more routes.

Further, in another instance, the method, in order to switch one or more locations between a pair of routes, further encompasses identifying via the processing unit [104], a pair of neighboring routes and thereafter the method comprises swapping via the processing unit [104], the one or more locations between identified pair of routes. Also, the determination of the route-pair in such instances may be based on a selection of an initial route at random, followed by identifying the one or more customers required to be removed from it, and then finding a neighboring route that is nearest to the one or more customers being removed. Also, in an instance the selection of route-pair and the one or more customers to be removed is further based on a reduction or elimination of a total capacity breach.

Also, in another instance, the method, in order to switch one or more locations between a pair of routes may comprise identifying via the processing unit [104], a cluster of customers that are placed in two or more existing routes. Further, for a pair of routes among the two or more existing routes, customer segments within each route are identified and swapped. Also, in one implementation the two customer segments, one in each route, are determined by also considering a capacity constraint requiring that the number of customers in each route is less than a threshold. Thereafter, the method further encompasses analyzing via the processing unit [104], an impact of a customer segment swap on an overall cost including cost associated with time-window violations. Further, the customer segment swaps iterates over all combinations of traversals of the customer segment pair.

Furthermore, in one more instance, the method encompasses identifying via the processing unit [104], one or more route pairs, based on ranking the one or more route pairs on the basis of distance between their centroids. Further, said one or more route pairs are identified for switching/swapping the one or more locations between them. Thereafter, the method comprises assigning via the processing unit [104], to the one or more route pairs, a probability inversely proportional to a square root of the rank, and thereafter the method encompasses determining the one or more route pairs based on that probability. Once the route pair is determined, the method comprises identifying the one or more locations/customer segments at random, both in terms of their starting index and their length with a constraint that it does not exceed a threshold, in order to further swap the one or more customer segments.

Furthermore, the ejection and re-insertion of the at least one location further comprises removing, via the processing unit [104], a first subset of locations from the one or more routes, followed by restoring, via the processing unit [104], the one or more routes based on a second subset of locations. Further, the first subset of locations comprises one or more locations that are required to be ejected from the one or more routes and the second subset of locations comprises one or more locations remaining in the one or more routes after ejecting/removing the first subset of locations. Also, the removal of the first subset of location from the one or more routes is further based on at least one of a proximity to a specific location, a random selection and an overall cost contribution.

Thereafter, while restoring the one or more routes after removal of the first subset of locations the method further comprises updating, via the processing unit [104], one or more time-windows associated with the second subset of locations.

Thereafter, the ejection and re-insertion of the at least one location further comprises, resetting, via the processing unit [104], one or more time-windows (to their original inputs) associated with the first subset of customers, followed by reinserting, via the processing unit [104], the first subset of locations, one at a time, into the one or more routes, based on the insertion cost. Further, in an instance a reinsertion order of one or more locations/customers of the first subset of locations may be based on a minimization of the insertion cost.

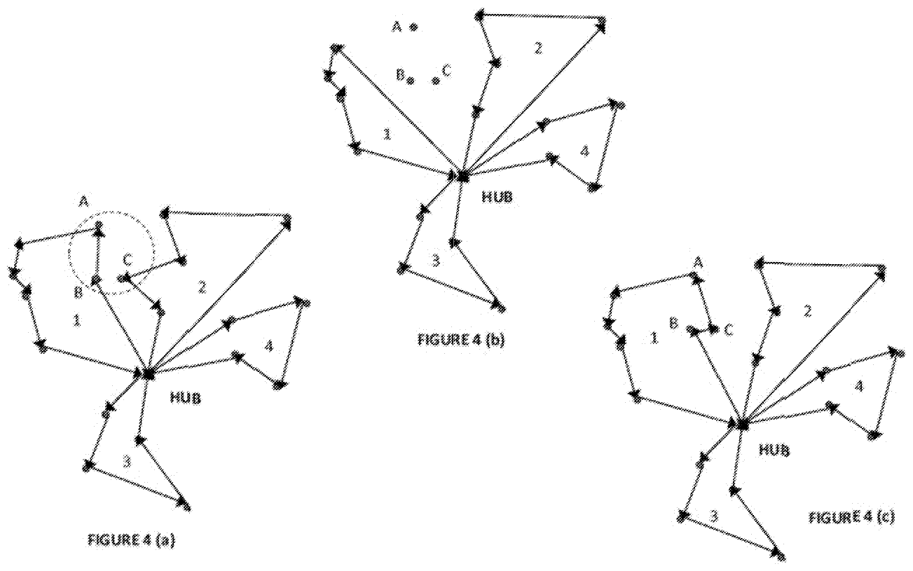

Furthermore, referring to FIG. 4, an example of modifying a set of routes, in accordance with exemplary embodiments of the present disclosure is shown.

FIG. 4 indicates a total of four routes namely route 1, route 2, route 3 and route 4.

Further, the FIG. 4 (a) indicates a determination of three customers/locations i.e. A, B and C to eject in the two routes i.e. route 1 and route 2.

Thereafter, the FIG. 4 (b) indicates a removal of three customers/locations from their respective routes, i.e. A, B from route 1 and C from route 2, followed by restoring the routes 1 and 2 after removing A, B and C locations.

Next, the FIG. 4 (c) indicates a reinsertion of the three identified customers/locations i.e. A, B and C into the routes based on an associated minimum insertion cost.

Thereafter, the method also encompasses modifying, iteratively, the initial set of routes in scenarios where time-window violations are inevitable. Therefore, in an implementation the criteria to identify at least one insertion location to insert the one or more locations may be based on a weighted linear combination of minimizing a total increase in travel time and an extent of breach (i.e., difference between an arrival time and an end of time-window of a customer). Also, the extent of breach is associated with a sum of increase in breaches of all customers/locations in the initial set of routes, upon inserting a new customer.

Also, in another operation the method in order to modify, iteratively, the determined initial set of routes further encompasses recursively transferring the one or more locations from one route to another route, wherein the recursive transfer is based on at least one of a sum of costs incurred in all the transfers and a capacity constraint of the route. Further, the cost associated with each move/transfer is compared to a regular insertion cost and the recursive transfer of the one or more locations is implemented only in an event it is favorable in comparison and indicates a reduced cost.

Further, in an implementation, the method comprises modifying iteratively, via the processing unit [104], the determined initial set of routes based on reconfiguring the ordering of locations on the route. For instance, the method in order to exchange/reorder one or more locations/customers between a pair of routes, encompasses optimizing each route independently by considering one or more standard edge-exchange operations within and between routes, such as all possible 2-edge exchanges and/or the like edge-exchange operations may be considered.

Next, in an implementation the method also encompasses reducing a computational complexity of one or more procedures, based on at least one of identifying, via the processing unit [104], at least one of a subset of neighboring locations of the one or more locations and a subset of routes, during the one or more location insertions, maintaining, via the processing unit [104], an information based on a cost computed from one or more previous iterations of the insertion of the one or more locations in the one or more routes at one or more locations to save re-computation in subsequent steps, eliminating, via the processing unit [104], one or more options in the one or more routes based on a shipment capacity and eliminating, via the processing unit [104], one or more options based on one or more time-windows and one or more serviceable times. Also, in an instance the method in order to eliminate the one or more options, based on the one or more time-windows and the one or more serviceable times also comprises determining via the processing unit [104], if the earliest (latest) arrival time at a next (previous) customer is greater (lesser) than its latest (earliest) serviceable time.

Also, in an implementation, the method comprises ensuring the requirements of the rest slot in every route. The rest slots are usually not dislodged from a route during inter-route reconfiguration operations; in instances involving swapping customer-segments/route-segments between a route pair, the move is permissible only when both the route-segments contain rest slots or neither of them do.

Also, in an instance, the method further encompasses modifying, iteratively, the determined initial set of routes based on at least one combination of above disclosed features to provide better route optimization during shipment deliveries and scheduling in heterogeneous hubs. Also, in an implementation various method parameters are learned adaptively from deployment of the method in different geographical locations. Furthermore, the method in order to select the at least one combination of above disclosed features, further comprises assigning via processing unit [104], probabilities to the above defined features based on how often the overall cost reduced when they were implemented in a past event.

Next, once the initial set of routes is modified, the method at step [210] comprises determining at each iteration, via the processing unit [104], a second cost associated with the modified set of routes and an acceptance criteria associated with one or more for the modifications. In an instance the second cost associated with the modified set of routes may further comprises a sum of total cost incurred to modify the initial set of routes.

Next, at step [212], the method comprises selecting, via the processing unit [104], a route modification criteria based on one or more iterations.

Further, at step [214], the method comprises arriving, via the processing unit [104], at a final set of routes based on a stopping criteria. Also, one implementation of the stopping criteria may be a total number of steps followed, based on which the processing unit [104] arrives at the final set of routes.

Also, the method further comprises storing at the storage unit [106], one or more data required to be stored in order to further implement the features of the present disclosure.

Thereafter, the method further terminates at step [216].

As it is evident from the above disclosure, the present disclosure provides systems and methods for vehicular fleet routing that provides better route optimization during one or more shipment deliveries and shipment scheduling in heterogeneous hubs. Furthermore, the present invention is significantly advantageous over the known solutions since the present invention not only helps in minimizing total travel time, but also limits outlier locations, produces an even distribution of shipments across the vehicles, keeps the routes compact and includes the rest slot in the optimization process. Further, in situations where time window violations are inevitable, the present invention minimizes the extent of the overall breach.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

We claim:

1. A method for vehicular fleet routing, the method comprising:
receiving, at a transceiver unit [102], at least one input comprising a set of locations to be serviced and a location of a hub;
determining, via a processing unit [104], an initial set of routes between the hub and the set of locations, the initial set of routes being associated with a first cost, wherein determining the initial set of routes further comprises:
inserting, iteratively, one or more un-routed locations into one or more partially constructed routes based on an insertion cost;
modifying, iteratively, via the processing unit [104], the determined initial set of routes based on at least one of:
ejection of at least one location from one or more routes and subsequent re-insertion of the ejected at least one location in the one or more routes, wherein the ejected at least one location is re-inserted one at a time, switching one or more locations between a pair of routes, and swapping one or more route segments between a pair of routes;
determining at each iteration, via the processing unit [104], a second cost associated with the modified set of routes and an acceptance criteria associated with one or more modifications;
selecting, via the processing unit [104], a route modification criteria based on one or more iterations; and
arriving, via the processing unit [104], at a final set of routes based on a stopping criteria.

2. The method as claimed in claim 1, wherein the at least one input further comprises a travel time between each pair of locations, a number of vehicles, a service time associated with each location, a number of shipments associated with each location and one or more maximum capacity details of each vehicle.

3. The method as claimed in claim 1, wherein the at least one input further comprises one or more serviceable time windows associated with each location.

4. The method as claimed in claim 1, the method further comprises scaling one or more cost components to adapt to one or more input conditions.

5. The method as claimed in claim 1, wherein the ejection and re-insertion further comprises:
removing, via the processing unit [104], a first subset of locations from the one or more routes of the initial set of routes,
restoring, via the processing unit [104], the one or more routes based on a second subset of locations,
updating, via the processing unit [104], one or more time-windows associated with the second subset of locations,
resetting, via the processing unit [104], one or more time-windows associated with the first subset of customers, and
reinserting, via the processing unit [104], the first subset of locations, one at a time, into the one or more routes, based on the insertion cost.

6. The method as claimed in claim 5, wherein the removal of the first subset of locations from the one or more routes is further based on at least one of a proximity to a specific location, a random selection and an overall cost contribution.

7. The method as claimed in claim 1, wherein the set of locations comprises one or more geographical details of the one or more locations to be serviced by the hub.

8. The method as claimed in claim 1, the method further comprises assigning via the processing unit [104], a rest slot within each route.

9. The method as claimed in claim 1, wherein the insertion cost is further based on at least one of an increase in a travel time, a shrinkage in time-window width, one or more penalties in an event the one or more locations are geographical outliers and a non-compactness of the set of locations constituting the one or more routes.

10. The method as claimed in claim 1, wherein the modifying iteratively, via the processing unit [104], the determined initial set of routes is further based on reconfiguring an ordering of the one or more locations on the one or more route.

11. The method as claimed in claim 1, wherein the modifying iteratively, via the processing unit [104], the determined initial set of routes further comprises recursively transferring the one or more locations from one route to another route, wherein the recursive transfer is based on at least one of a sum of costs incurred in all the transfers and a capacity constraint of the route.

12. The method as claimed in claim 1, the method further comprises reducing a computational complexity, based on at least one of:
identifying, via the processing unit [104], at least one of a subset of neighboring locations of the one or more locations and a subset of routes, during the one or more location insertions;
maintaining, via the processing unit [104], an information based on a cost computed from one or more previous iterations of the insertion of the one or more locations in the one or more routes;
eliminating, via the processing unit [104], one or more options in the one or more routes based on a shipment capacity; and
eliminating, via the processing unit [104], one or more options based on one or more time-windows and one or more serviceable times.

13. A system for vehicular fleet routing, the system comprising:
a transceiver unit [102], configured to receive, at least one input comprising a set of locations to be serviced and a location of a hub;
a processing unit [104], configured to:
determine, an initial set of routes between the hub and the set of locations, the initial set of routes being associated with a first cost, wherein the processing unit [104] in order to determine the initial set of routes is further configured to:
insert, iteratively, one or more un-routed locations into one or more partially constructed routes based on an insertion cost;
modify, iteratively, the determined initial set of routes based on at least one of:
ejection of at least one location from one or more routes and subsequent re-insertion of the ejected at least one location in the one or more routes, wherein the ejected at least one location is re-inserted one at a time,
switching one or more locations between a pair of routes, and
swapping one or more route segments between a pair of routes;
determine, at each iteration, a second cost associated with the modified set of routes and an acceptance criteria associated with one or more modifications;
select, a route modification criteria based on one or more iterations; and
arrive, at a final set of routes based on a stopping criteria.

14. The system as claimed in claim 13, wherein the at least one input further comprises at least one travel time between each pair of locations, a number of vehicles, a service time associated with each location, a number of shipments associated with each location and one or more maximum capacity details of each vehicle.

15. The system as claimed in claim 13, wherein the at least one input further comprises one or more serviceable time windows associated with each location.

16. The system as claimed in claim 13, wherein the processing unit [104] is further configured to scale one or more cost components to adapt to one or more input conditions.

17. The system as claimed in claim 13, wherein the processing unit [104], in order to eject and re-insert the at least one location, is further configured to:
remove, a first subset of locations from the one or more routes of the initial set of routes,
restore, the one or more routes based on a second subset of locations, update, one or more time-windows associated with the second subset of locations,
reset, one or more time-windows associated with the first subset of customers, and
reinsert, via the first subset of locations, one at a time, into the one or more routes, based on the insertion cost.

18. The system as claimed in claim 17, wherein the removal of the first subset of locations from the one or more routes is further based on at least one of a proximity to a specific location, a random selection and an overall cost contribution.

19. The system as claimed in claim 13, wherein the set of locations comprises one or more geographical details of the one or more locations to be serviced by the hub.

20. The system as claimed in claim 13, wherein the processing unit [104], is further configured to assign a rest slot within each route.

21. The system as claimed in claim 13, wherein the insertion cost is further based on at least one of an increase in a travel time, a shrinkage in time-window width, one or more penalties in an event the one or more locations are geographical outliers and a non-compactness of the set of locations constituting the one or more routes.

22. The system as claimed in claim 13, wherein the processing unit [104], in order to modify iteratively, the determined initial set of routes, is further configured to reconfigure an ordering of the one or more locations on the one or more routes.

23. The system as claimed in claim 13, wherein the processing unit [104] in order to modify, iteratively, the determined initial set of routes is further configured to transfer recursively the one or more locations from one route to another route, wherein the recursive transfer is based on at least one of a sum of costs incurred in all the transfers and a capacity constraint of the route.

24. The system as claimed in claim 13, wherein the processing unit [104], in order to reduce a computational complexity, is further configured to:
identify, at least one of a subset of neighboring locations of the one or more locations and a subset of routes, during the one or more location insertions;
maintain, an information based on a cost computed from one or more previous iterations of the insertion of the one or more locations in the one or more routes;
eliminate, one or more options in the one or more routes based on a shipment capacity; and
eliminate, one or more options based on one or more time-windows and one or more serviceable times.
